(19) United States
(12) Patent Application Publication
(10) Pub. No.: US 2010/0076734 A1
(43) Pub. Date: Mar. 25, 2010

(54) Method for simulating the ventilation of a liquid tank

(75) Inventors: Eric VOLTO, Suresnes (FR); Pierre LACOME, Lachelle (FR)

Correspondence Address: Solvay;c/o B. Ortego - IAM-NAFTA, 3333 Richmond Avenue, Houston, TX, 77098-3099, US

(73) Assignee: INERGY AUTOMOTIVE SYSTEMS RESEARCH (Societe Anonyme), Brussels (BE)

(21) Appl. No.: 12/490,502

(22) Filed: Jun. 24, 2009

(30) Foreign Application Priority Data
Jun. 24, 2008 (FR) 08.54185

(51) Int. Cl. G06G 7/57; G06F 17/10; G06G 7/48

(52) U.S. Cl. 703/2; 703/9; 703/7

(57) ABSTRACT

Method for simulating the ventilation of a liquid tank (1,101), in particular a liquid fuel tank of a vehicle, comprising an internal volume (3,103), a wall (2,102) that defines said internal volume (3,103), and a set of valves (4a,4b;104) for ventilation of the internal volume, said method comprising the calculation of a maximum liquid volume that can be ventilated (14,114) for a maximum angle of inclination of the tank (1,101).Such method also comprises the calculation of at least one maximum liquid volume that can be ventilated (14,114) for at least one intermediate angle of inclination below said maximum angle, but above zero.

### CROSS-REFERENCE TO RELATED APPLICATIONS

This nonprovisional application claims priority benefit to French Application No. 0854184 filed Jun. 24, 2008, this application being herein incorporated by reference in its entirety for all purposes.

The present invention relates to a method for simulating the ventilation of a liquid tank, in particular a liquid fuel tank of a vehicle, comprising an internal volume, a wall that defines said internal volume, and a set of valves for ventilation of the internal volume, by means of a data processing device containing a virtual model of the tank.

The expression “liquid tank” is understood to mean any tank for a liquid of any nature. The invention preferably applies to those that are mounted on motorized vehicles such as motor vehicles, such as fuel tanks or tanks for pollution-control additives (for example urea, which is used to reduce the NOx in the exhaust gases). It applies more particularly to liquid fuel tanks.

Such tanks may be manufactured by any known technique before being equipped with the liquid gauge. They may, for example, be obtained by pressing and/or welding steel sheets, by extrusion-blow moulding of parisons made of plastic of various types, by pouring or injecting various materials into a mould or by any other technique suitable for the manufacture of closed hollow objects capable of containing liquids. The invention is particularly suitable for the simulation of plastic tanks, more particularly those obtained by the extrusion-blow moulding technique.

The term “vehicle” is understood to mean any mobile machine that can be moved in any direction that varies in the course of the movement along a slope that may itself also vary with the movement and more particularly those that can be moved over a horizontal or sloping surface.

The expression “data processing device” is understood to mean any programmable device that makes it possible to process a data set, in particular in the form of computer data files, according to a set of logic instructions, or software. In particular, it is understood to mean, in this way, any programmable electronic computer.

The expression “electronic medium” is understood to mean any data storage device that can be read by such a data processing device such as, for example, an optical memory device such as a CD-Rom, DVD, or others, a magnetic memory device such as a hard disk, magnetic tape, floppy disk, or others, or an electronic memory device such as a memory chip, flash memory or others.

The terms virtual model or software are understood to mean any detailed description in the form of computer data files, in particular computer data files capable of being processed by computer-aided design (CAD) software.

The expression “ventilation valve” is understood to mean any duct equipped with closure means that preferably allow the passage of gas in both directions, but that close to prevent the passage of liquid.

A liquid tank is normally closed in order to prevent liquid losses. However, a hermetically sealed tank would present a risk of bursting because of excessive pressures due to thermal expansion and/or evaporation of the liquid. On the other hand, the progressive consumption of the liquid in the tank would result in a vacuum in the tank, which could end up by preventing the extraction of the liquid by a fuel pump. Moreover, in particular when the tank is tilted, the formation of air pockets in the tank may limit the volume of liquid during filling.

The purpose of the set of ventilation valves, with which fuel tanks are generally equipped, is to prevent these two drawbacks. However, since each ventilation valve closes when the level of liquid in the tank reaches it, if the level of liquid rises above that of all the ventilation valves, the tank will no longer be able to be ventilated. The expression “maximum liquid volume that can be ventilated” is understood to mean the maximum volume of liquid in the tank for a certain inclination of the tank, for which at least one valve from said set of ventilation valves is not yet submerged beneath the liquid and can therefore still ventilate said tank, it being understood that for any volume greater than this volume, the tank will no longer be ventilated. In order to validate the shape and volume of the tank and also the positioning of the set of ventilation valves, it is advantageous to simulate the ventilation of the tank on a virtual model of the tank.

The software “Fuel Tank Simulator v. 3.0” by Drutech Corp. proposes a method for simulating the ventilation of a liquid tank, in particular a liquid fuel tank of a vehicle, comprising an internal volume, a wall that defines said internal volume, and a set of valves for ventilation of the internal volume, by means of a data processing device containing a virtual model of the tank, and comprising the calculation of a maximum liquid volume that can be ventilated for a maximum angle of inclination of the tank.

However, it has been unexpectedly discovered that, due to the complex shapes of the tanks, the critical angle of inclination of the tank may not be the angle of maximum inclination: the maximum liquid volume that can be ventilated may indeed sometimes be smaller for a smaller angle. The simulation method of the prior art therefore has the drawback of possibly indicating a maximum liquid volume that can be ventilated, which is greater than the actual maximum liquid volume that can be ventilated.

The objective of the simulation method of the invention is therefore to better specify the critical volume of liquid in the tank, and also, preferably, the corresponding angle of inclination.

For this, the simulation method of the invention also comprises the calculation of at least one maximum liquid volume that can be ventilated for at least one intermediate angle of inclination below said limiting angle, but above zero. It should be noted that the maximum angle associated to this maximum liquid volume that can be ventilated could be zero in the case where there is no ventilation possible in a horizontal position, but this is then an incorrect design which may often be identified without calculation. In practice, the domain of the angles of inclination to be studied (which therefore ranges from an angle 0 to the limiting angle) is discretized as a function of its size so as to determine, for example, five exact points. The intermediate points (which complete the curve) are then obtained by interpolation. It is possible to be more precise, to the detriment of the calculation speed. Five exact calculation points constitutes a good compromise in practice.

Preferably, said maximum volumes may be calculated for several angles of orientation of said inclination of the tank.

Within the context of the invention:
the expression “angle of inclination” or angle of slope, is understood to mean the angle θ that a reference plane of the tank makes with the horizontal; in an orthogonal coordinate system it is possible to define two orthogonal axes X and Y included in the reference plane (for example: the X axis going from the front to the rear of the vehicle and the Y axis going from left to the right of the vehicle) and a Z axis orthogonal to this plane; the angle θ is then the angle through which the Z axis has swung in the inclined (sloping) position of the tank; and
the expression “angle of orientation” or of direction, is understood to mean the angle α about which the inclination is applied; in the orthogonal coordinate system defined above, this is in fact the angle that the perpendicular to the axis about which the reference plane has swung makes with the X axis (or the angle that the axis about which the reference plane has swung makes with the Y axis).

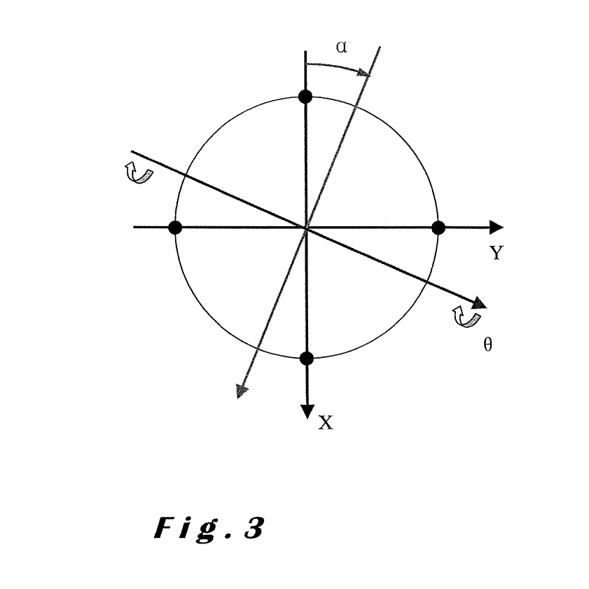

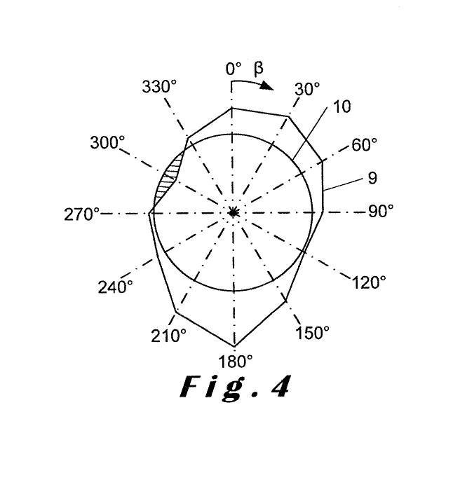

FIG. 3 appended to the present document schematically illustrates these definitions.

Preferably, the smallest of the maximum volumes calculated by varying the angle of inclination (θ) between 0 and its maximum value is identified as the critical liquid volume at various values of the angle of orientation (α) and this volume is entered in a spider graph. It is also possible to enter the value of the angle associated with this critical volume, or critical angle, in a spider graph, again as a function of the angle of orientation (α).

In practice, two spider graphs are often generated:
a first giving the critical liquid volume as a function of the direction; and
a second giving the critical angle (i.e. the angle associated with this critical volume) as a function of the direction.

The aforementioned two spider graphs are, of course, specific to a given tank equipped with a given system of valves.

In the invention, the aforementioned calculations and the production of the graphs may be carried out manually, on the basis of experimental results obtained on a tank prototype. However, advantageously, these operations are carried out by software (or a data processing device) containing a virtual model of the tank and features relating to the valves (geometry and location in the tank). The present invention furthermore aims also to cover such software and also any electronic medium or data processing device incorporating such software.

With such software, it is possible to see after one loop (calculation) which are the valves that ventilate and which are the ones that are submerged. In order to optimize the system, it then suffices to restart a new calculation with new positions of the valves. Therefore, in order to optimize the system automatically, it will be necessary to launch n calculation loops by varying the position and the number of the valves. The result will be a set of solutions that meet the initial specification. The choice of the final solution from among this set of solutions is generally the responsibility of the user.

If the tank is a saddle tank with an internal volume comprising two lower pockets and a predetermined point for transfer of liquid between the two pockets (or vice versa in the case of a U-shaped or inverted saddle tank), considering a same level of liquid in the two pockets may underestimate the maximum liquid volume that can be ventilated. Indeed, with an inclined tank, the highest of the lower pockets may be filled up to the level of the liquid transfer point before the other pocket begins to be filled. Preferably, said simulation method may therefore comprise, in addition, the calculation of the volume of the highest of the lower pockets up to the level of the liquid transfer point.

The present invention also relates to a method for producing a liquid tank, in particular a liquid fuel tank for a vehicle, based on a virtual model of the tank, characterized in that the shape and volume of the tank, and also the placement of a set of ventilation valves are validated by the simulation method according to the invention before physical manufacture of said tank.

As already mentioned above, the present invention also relates to a data processing device programmed to carry out said simulation method, to software for carrying out said simulation method and to an electronic medium that can be read by a data processing device and that comprises software enabling said data processing device to carry out said simulation method.

Details regarding the invention are described below with reference to the drawings:

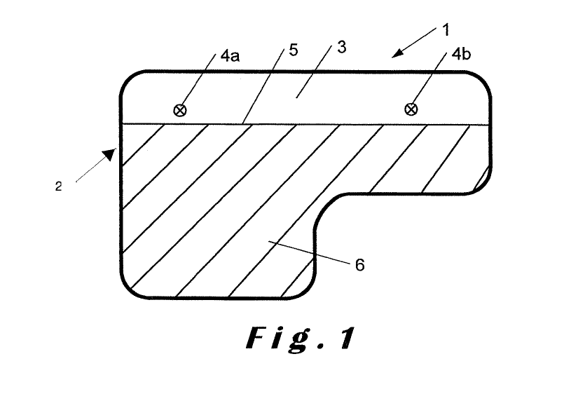

FIG. 1 schematically presents a one-piece liquid tank;

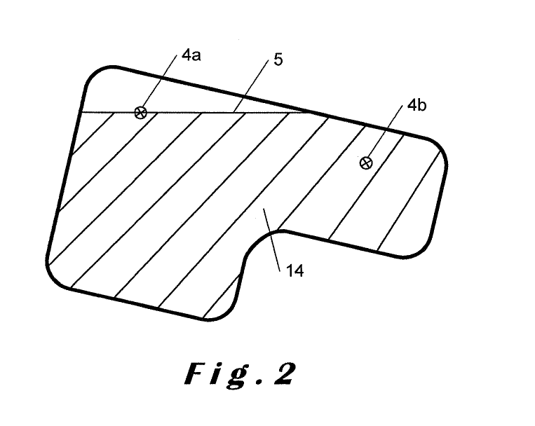

FIG. 2 presents the tank from FIG. 1 in an inclined position;

FIG. 3 presents a schematic view of the angles that characterize a plane inclined relative to a reference plane;

FIG. 4 presents a spider graph of the maximum volume of liquid that can be ventilated in a tank for a certain angle of inclination, as a function of the angle of orientation of this inclination;

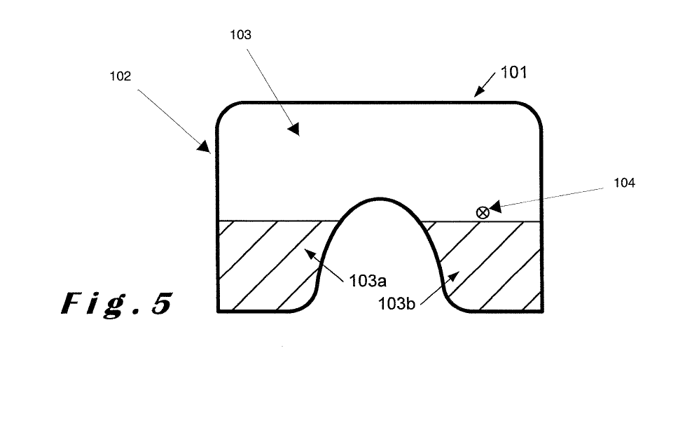

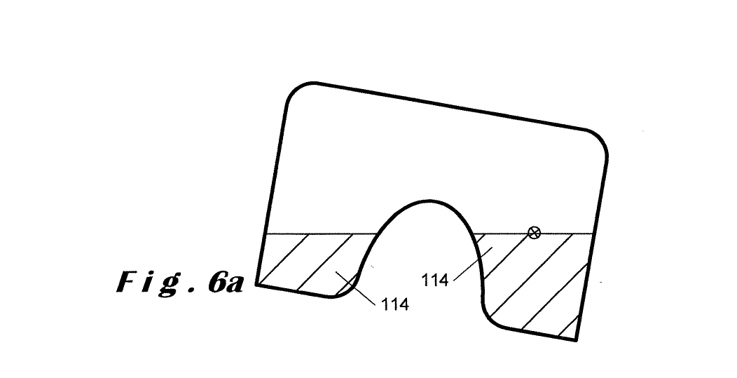

FIG. 5 schematically presents a saddle-shaped liquid tank; and

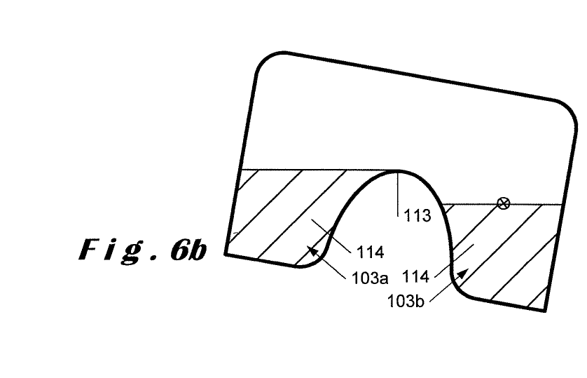

FIGS. 6a and 6b present the tank from FIG. 5 in an inclined position.

A typical example of a liquid fuel tank 1 for a motor vehicle is represented schematically in FIG. 1. This tank 1 comprises a wall 2 that defines an internal volume 3 and, in this internal volume 3, two ventilation valves 4a and 4b. As these ventilation valves 4a, 4b are placed in an upper zone of the tank 1, they normally remain above the level of the liquid. However, when the tank 1 is quite full, and especially when it is inclined, the two valves 4a, 4b may find themselves submerged beneath the free surface 5 of the liquid 6, and therefore closed.

In a first embodiment of the simulation method according to the present invention, a virtual model of the tank 1 is used to simulate several inclinations of the tank 1, such as that illustrated in FIG. 2. The angles of inclination θ and of orientation α of this inclination, are as defined previously and illustrated in FIG. 3. The tank 1 is therefore simulated with a zero inclination, with an angle of maximum inclination, and with at least an angle of intermediate inclination and this with several angles of orientation α of the inclination, varying from 0° to 360° in steps of 30° in the case illustrated in FIG. 4. In other words: for each value of the angle α, the maximum volume that can be ventilated is calculated for several (at least 3) inclination angles.

It is then possible to represent the minimum of those values (i.e, the critical volume) as a function of the angle α of orientation of the inclination by a curve 9 in a spider graph, as illustrated in FIG. 4. On such a spider graph, an accepted minimum value of said critical volume is represented by a boundary 10 in the shape of a circumference. Passing below this boundary can therefore be easily assessed. Several curves 9 corresponding to gauging errors for various angles of inclination a may be represented in one and the same spider graph.

If the smallest of the critical volumes calculated in this step (and which, in the case illustrated, is obtained for α=300° is still above the minimum value accepted by the vehicle manufacturer, the tank 1 may be considered to be validated. The critical angle of inclination associated with the critical volume may also be represented in a spider graph as a function of the angle α of orientation of the inclination.

If the tank 1 is not validated by this simulation method, it is then possible to proceed to an iteration in order to optimize the placement of the ventilation valves and/or the shape of the tank 1 before manufacturing the tank 1 by means known to a person skilled in the art such as, for example, extrusion-blow moulding of a plastic, in particular a thermoplastic.

In this simulation method, it is also possible to identify those of the ventilation valves 4a, 4b that remain above the liquid level, and therefore that remain open in each position of the tank 1, and to represent this information in graphical form. Another embodiment of the simulation method according to the present invention applies to saddle tanks, such as the tank 101 illustrated in FIG. 5. The tank 101 comprises a wall 102 that defines an internal volume 103 with two lower pockets 103a and 103b and, in this internal volume 103, a ventilation valve 104.

In an inclined position, such as illustrated in FIGS. 6a and 6b, assuming a same level of liquid for the two lower pockets 103a, 103b, could lead to an underestimation of the maximum liquid volume that can be ventilated 114, as illustrated in FIG. 6a. In fact, as is illustrated in FIG. 6b, the lower pocket 103a, higher than the lower pocket 103b in the position illustrated, may be filled up to a liquid transfer point 113 before liquid begins to be transferred to the other pocket 103b, resulting in a maximum liquid volume that can be ventilated 114 larger than that illustrated in FIG. 6a. For this reason, the simulation method according to this other embodiment comprises a step of calculating the volume of the lower pocket 103a up to the liquid transfer point 113 in order to calculate the maximum liquid volume that can be ventilated 114 in this position.

Similar reasoning may be applied to U-shaped (or inverted saddle) tanks.

Although the present invention has been described with reference to one specific exemplary embodiment, it is obvious that modifications and changes can be carried out on these examples without departing from the general scope of the invention as defined by the claims. Consequently, the description and the drawings should be considered in an illustrative rather than restrictive sense.

1. A method for simulating the ventilation of a liquid tank (1,101), in particular a liquid fuel tank of a vehicle, comprising an internal volume (3,103), a wall (2,102) that defines said internal volume (3,103), and a set of valves (4a,4b;104) for ventilation of the internal volume, said method comprising the calculation of a maximum liquid volume that can be ventilated (14,114) for a maximum angle of inclination of the tank (1,101), this method also comprising the calculation of at least one maximum liquid volume that can be ventilated (14,114) for at least one intermediate angle of inclination below said maximum angle, but above zero.

2. The simulation method according to claim 1, wherein the angular domain to be studied is discretized as a function of its size so as to determine five exact points, and wherein the intermediate points are obtained by interpolation.

3. The simulation method according to claim 1, wherein the maximum volumes (14,114) are calculated for several angles (α) of orientation of the inclination of the tank (1,101).

4. The simulation method according to claim 3, wherein the smallest of the maximum volumes calculated by varying the angle of inclination (θ) between 0 and its maximum value is identified as the critical liquid volume at various values of the angle of orientation (α); and wherein this critical volume is entered in a spider graph.

5. The simulation method according to claim 4, wherein the value of the critical angle of inclination associated with the critical volume is entered in a spider graph as a function of the angle of orientation (α).

6. The simulation method according to claim 1, said method using a data processing device containing a virtual model of the tank (1,101) and features relating to the valves (geometry and location in the tank).

7. The simulation method according to claim 6, wherein the software carries out a first calculation loop in order to determine which are the valves that ventilate and which are the ones that are submerged; wherein said software then carries out n calculation loops by varying the position and number of valves in order to generate a set of solutions that meet a specification.

8. The simulation method according to claim 1, wherein the smallest of the maximum volumes calculated (14,114) is identified as the critical liquid volume.

9. The simulation method according to claim 8, said method also comprising a step of calculating a maximum angle (θₘₐₓ) of inclination for which said critical liquid volume may also be ventilated by at least one valve from said set of ventilation valves (4a,4b;104).

10. The simulation method according to claim 1, wherein said tank (101) is a saddle tank, the internal volume (103) of which comprises two lower pockets (103a,103b) and a predetermined point (113) for transfer of liquid between the two pockets (103a,103b), and wherein the calculation of at least one maximum liquid volume that can be ventilated (114) comprises the calculation of the volume of the highest of the lower pockets (103a,103b) up to the level of the liquid transfer point (113).

11. A method for producing a liquid tank (1,101), in particular a liquid fuel tank for a vehicle, based on a virtual model of the tank, wherein the shape and volume of the tank (1,101), and also the placement of a set of ventilation valves (4a,4b;104) are validated by a simulation method according to claim 1 before physical manufacture of said tank (1,101).

12. A data processing device programmed to carry out the simulation method according to claim 1.

13. A software for carrying out the simulation method according to claim 1.

14. An electronic medium comprising a software that enables a data processing device to carry out the simulation method according to claim 1.
